(19) United States
(12) Patent Application Publication
(10) Pub. No.: US 2022/0300223 A1
(43) Pub. Date: Sep. 22, 2022

(54) PRINTER AND INFORMATION PROCESSING SYSTEM

(71) Applicant: TOSHIBA TEC KABUSHIKI KAISHA, Tokyo (JP)

(72) Inventors: Charissa Castaneda GARCIA, Singapore (SG); Hiroyuki INABA, Izunokuni Shizuoka (JP)

(73) Assignee: TOSHIBA TEC KABUSHIKI KAISHA, Tokyo (JP)

(21) Appl. No.: 17/592,061

(22) Filed: Feb. 3, 2022

(30) Foreign Application Priority Data
Mar. 17, 2021 (JP) 2021-043680

(51) Int. Cl. G06F 3/12

(52) U.S. Cl. CPC G06F 3/1234; G06F 3/121; G06F 3/128

(57) ABSTRACT

A printer capable of providing a replication of communication data without using an external device includes a first communication interface, a second communication interface, and a processor. The first communication interface includes a first integrated circuit and a first buffer configured to store first communication data, and is communicably connected to a user terminal. The second communication interface includes a second integrated circuit and a second buffer configured to store second communication data, and is communicably connected to an analysis terminal. The processor is configured to store the first communication data in the first buffer and store the second communication data, generated by replicating the first communication data, in the second buffer.

### CROSS-REFERENCE TO RELATED APPLICATION

This application is based upon and claims the benefit of priority from Japanese Patent Application No. 2021-043680, filed on Mar. 17, 2021, the entire contents of which are incorporated herein by reference.

### FIELD

Embodiments described herein relate to a printer and an information processing system.

### BACKGROUND

In a system that performs universal serial bus (USB) communication, an error may occur in USB communication data between a USB host device such as a personal computer (PC) of a user and a USB function device such as a printer or a scanner. For example, there is a case in which print data transmitted from a PC of a user cannot be accurately printed in a printer due to some error. When such an error occurs, the USB communication data is acquired and analyzed using an external analysis device such as a protocol analyzer.

However, the external analysis device as described above is expensive and large, and many users often do not possess the external analysis device. A service person or the like who performs maintenance of a printer or the like needs to acquire and analyze communication data by bringing an external analysis device to an installation location of a user device.

### DESCRIPTION OF THE DRAWINGS

FIG. 1 is a block diagram depicting an information processing system according to at least one exemplary embodiment;

FIG. 2 is a schematic diagram showing a main part of a printer according to at least one exemplary embodiment;

FIG. 3 is a flowchart describing processing of received data executed by a processor according to at least one exemplary embodiment; and

FIG. 4 is a flowchart describing processing of transmitted data executed by the processor according to at least one exemplary embodiment.

### DETAILED DESCRIPTION

In general, according to at least one embodiment, a technique capable of providing a replication of communication data without using an external device is provided.

According to at least one embodiment, a printer includes a first communication interface, a second communication interface, and a processor. The first communication interface includes a first integrated circuit and a first buffer configured to store first communication data, and is communicably connected to a user terminal. The second communication interface includes a second integrated circuit and a second buffer configured to store second communication data, and is communicably connected to an analysis terminal. The processor is configured to store the first communication data in the first buffer and store the second communication data, generated by replicating the first communication data, in the second buffer.

Hereinafter, at least one exemplary embodiment will be described with reference to the Figures.

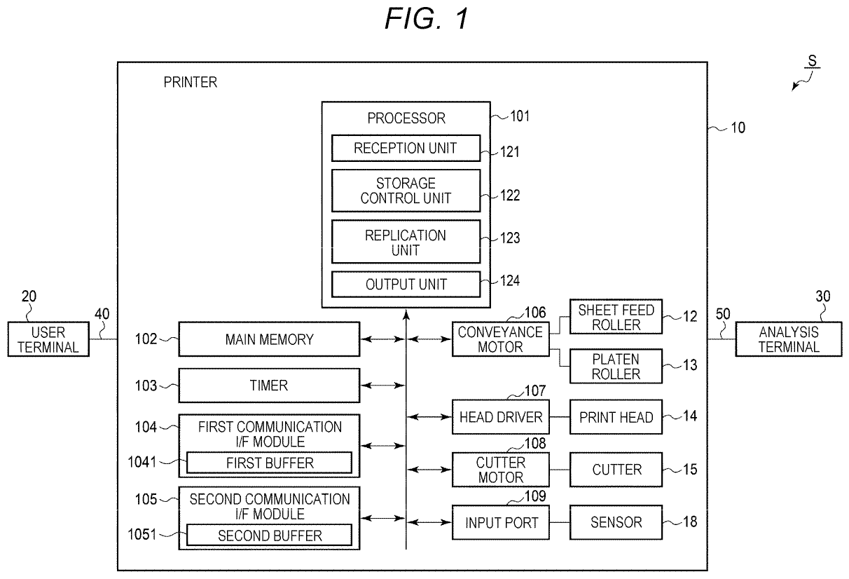

FIG. 1 is a block diagram exemplifying an information processing system S.

The information processing system S includes a printer 10, a user terminal 20, and an analysis terminal 30.

The printer 10 is an electronic device (e.g., electronic apparatus, etc.) that prints, on a recording medium, an image based on print data received from the user terminal 20. For example, the printer 10 is a thermal printer, an inkjet printer, or the like. The printer 10 will be described by taking a thermal printer as an example. The printer 10 receives the print data from the user terminal 20 via a first communication interface module 104. An exemplary configuration of the printer 10 will be described below. In FIG. 1, an interface is described as “I/F”.

The user terminal 20 is an electronic device (e.g., electronic apparatus, etc.) capable of communicating with other electronic devices. The user terminal 20 is, for example, a device used by a user. For example, the user terminal 20 is a personal computer (PC), a smartphone, a tablet terminal, or the like. The user terminal 20 is a device including a communication unit that communicates, with the printer 10, communication data between the printer 10 and the user terminal 20. For example, the communication unit includes a communication interface module of the same standard as a standard of the first communication interface module 104. The communication data between the printer 10 and the user terminal 20 corresponds to the communication data related to the user terminal 20. The communication data related to the user terminal 20 is an example of the first communication data. The first communication data includes received data or transmitted data. The received data corresponds to communication data received by the printer 10 from the user terminal 20. The transmitted data corresponds to communication data output by the printer 10 to the user terminal 20. The user may be understood as a customer or a person. The user terminal 20 is an example of a first device.

The analysis terminal 30 is an electronic device (e.g., electronic apparatus, etc.) capable of communicating with other electronic devices. The analysis terminal 30 is, for example, a device used by an administrator of the printer 10, a service person who performs maintenance work, or the like. For example, the analysis terminal 30 is a PC, a smartphone, a tablet terminal, or the like. The analysis terminal 30 is a device including a communication unit that communicates, with the printer 10, communication data between the printer 10 and the analysis terminal 30. For example, the communication unit includes a communication interface module of the same standard as a standard of a second communication interface module 105. The communication data between the printer 10 and the analysis terminal 30 is an example of the second communication data to be described below. The analysis terminal 30 is an example of a second device.

At least one exemplary embodiment or configuration of the printer 10 will be described.

Referring to FIG. 1, the printer 10 includes a sheet feed roller 12, a platen roller 13, a print head 14, a cutter 15, a sensor 18, a processor 101, a main memory 102, a timer 103, a first communication interface module 104, a second communication interface module 105, a conveyance motor 106, a head driver 107, a cutter motor 108, and an input port 109. The processor 101 is electrically and communicably connected to the main memory 102, the timer 103, the first communication interface module 104, the second communication interface module 105, the conveyance motor 106, the head driver 107, the cutter motor 108, and the input port 109. Exemplary configurations of the sheet feed roller 12, the platen roller 13, the print head 14, the cutter 15, and the sensor 18 will be described below.

The processor 101 corresponds to a central part of the printer 10. For example, the processor 101 is a central processing unit (CPU), but is not limited thereto. The processor 101 may be implemented by various circuits. The processor 101 loads a program stored in advance in the main memory 102 into the main memory 102. The program is a program that causes the processor 101 of the printer 10 to achieve or execute each unit described below. The processor 101 executes various operations by executing the program loaded in the main memory 102.

The main memory 102 corresponds to a main storage part of the printer 10. The main memory 102 includes a nonvolatile memory region and a volatile memory region. The main memory 102 stores an operating system or a program in the nonvolatile memory region. The main memory 102 uses the volatile memory region as a work area in which data is appropriately rewritten by the processor 101. For example, the main memory 102 includes a read only memory (ROM) as the nonvolatile memory region. For example, the main memory 102 includes a random access memory (RAM) as the volatile memory region. The main memory 102 stores a program.

The timer 103 measures a preset time. The timer 103 times out if the set time is measured. The set time may be any set time. The timer 103 resets the time measured under the control of the processor 101.

The first communication interface module 104 includes various interfaces that communicably connect the printer 10 to other electronic devices via a first network 40 in accordance with a predetermined communication protocol. The first communication interface module 104 communicably connects the printer 10 to the user terminal 20. The first communication interface module 104 performs data communication with the user terminal 20 under the control of the processor 101. For example, in at least one embodiment, the first communication interface module 104 is a USB module including an integrated circuit that executes communication according to the USB standard. The first communication interface module 104 controls various functions on a USB host device side in USB communication. The USB host device corresponds to the user terminal 20. The first communication interface module 104 includes a first buffer 1041. The first communication interface module 104 may include an engine that controls a USB protocol, a register that stores settings of the USB communication, and the like. The first communication interface module 104 is an example of the first interface module.

The first buffer 1041 is a memory that temporarily stores data to be communicated between the printer 10 and the user terminal 20. The first network 40 is a network conforming to a standard of the first communication interface module 104. For example, the first network 40 is a network implemented by a USB cable that connects the printer 10 and the user terminal 20 in a wired manner.

The second communication interface module 105 includes various interfaces that communicably connect the printer 10 to other electronic devices via a second network 50 in accordance with a predetermined communication protocol. The second communication interface module 105 communicably connects the printer 10 to the analysis terminal 30. The second communication interface module 105 performs data communication with the analysis terminal 30 under the control of the processor 101. For example, in at least one embodiment, the second communication interface module 105 is a module implemented by an integrated circuit that executes wired communication or wireless communication according to a standard such as a local area network (LAN), Bluetooth (registered trademark), or Wi-Fi (registered trademark). The second communication interface module 105 controls various functions of the analysis terminal 30. The second communication interface module 105 includes a second buffer 1051. The second communication interface module 105 may include an engine that controls a communication protocol, a register that stores settings of the communication, and the like. The second communication interface module 105 is an example of the second interface module.

The second buffer 1051 is a memory that temporarily stores data to be communicated between the printer 10 and the analysis terminal 30. The second network 50 is a network conforming to a standard of the second communication interface module 105. The second network 50 is a network implemented by a cable that connects the printer 10 and the analysis terminal 30 in a wired manner, or a network that connects the printer 10 and the analysis terminal 30 in a wireless manner.

The conveyance motor 106 drives the sheet feed roller 12 and the platen roller 13. The sheet feed roller 12 and the platen roller 13 are rotated in a predetermined direction by being driven by the conveyance motor 106, and convey the strip-shaped sheet wound in a roll shape to a sheet supplying port. The sheet is an example of the recording medium.

The head driver 107 is a drive circuit that drives the print head 14. The print head 14 prints an image based on the print data from the user terminal 20 on a sheet 19 by being driven by the head driver 107. The print includes meaning of printing. The print head 14 is also referred to as a thermal head.

The cutter motor 108 drives a movable blade of the cutter 15. The cutter motor 108 is capable of driving the movable blade in two stages of a partial-cut drive and a full-cut drive. If the cutter motor 108 performs the partial-cut drive, the cutter 15 performs a partial cutting in which a part of the sheet is left to be cut. If the cutter motor 108 performs full-cut drive, the cutter 15 performs a full cutting by completely cutting the sheet.

The input port 109 inputs an ON signal or an OFF signal output from the sensor 18. The processor 101 determines whether the sensor 18 detects the sheet based on the signal input to the input port 109.

A hardware configuration of the printer 10 is not limited to the above-described exemplary configuration. It is possible to appropriately omit and change the above-described components for the printer 10 and add new components to the printer 10.

Each unit implemented in the above-described processor 101 will be described.

Referring to FIG. 1, the processor 101 includes a reception unit 121, a storage control unit 122, a replication unit 123, and an output unit 124. Each unit implemented in the processor 101 can also be referred to as each function. It can also be said that each unit implemented in the processor 101 is implemented in a control unit including the processor 101 and the main memory 102.

The reception unit 121 receives the data output from the user terminal 20 via the first communication interface module 104. The data includes print data, various commands, and the like. The command includes a command for causing the printer 10 to output various types of setting information of the printer 10, a command for causing the printer 10 to output information indicating a state of the printer 10, and the like. The state of the printer 10 includes an error occurrence state such as a jam of the printer 10. The command is periodically output from the user terminal 20 to the printer 10. The reception unit 121 periodically receives a command from the user terminal 20. The command may be a known command.

The storage control unit 122 stores, in the first buffer 1041, communication data between the printer 10 and the user terminal 20.

The storage control unit 122 stores the data received by the reception unit 121 in the first buffer 1041. The first buffer 1041 stores received data. Each time the reception unit 121 receives the data, the storage control unit 122 stores the received data in the first buffer 1041. The first buffer 1041 stores the received data each time the reception unit 121 receives the data.

The storage control unit 122 stores the transmitted data in the first buffer 1041. The transmitted data includes a response to the command received by the reception unit 121.

The storage control unit 122 stores the second communication data generated by the replication unit 123, which will be described below, in the second buffer 1051. The second buffer 1051 stores the second communication data. Each time the replication unit 123 generates the second communication data, the storage control unit 122 stores the second communication data in the second buffer 1051. The second buffer 1051 stores the second communication data each time the replication unit 123 generates the second communication data.

The replication unit 123 replicates the first communication data stored in the first buffer 1041. The replication unit 123 replicates the first communication data to generate communication data. The communication data generated by the replication unit 123 corresponds to the second communication data.

The output unit 124 outputs the first communication data stored in the first buffer 1041 to the user terminal 20 via the first communication interface module 104. The output unit 124 outputs the second communication data stored in the second buffer 1051 to the analysis terminal 30 via the second communication interface module 105.

An exemplary embodiment of a main part of the printer 10 will be described.

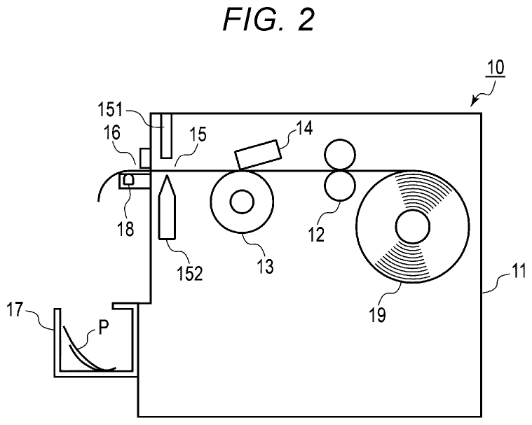

FIG. 2 is a schematic diagram showing the main part of the printer 10 according to the exemplary embodiment.

Referring to FIG. 2, the printer 10 includes a housing 11 capable of accommodating the sheet 19. Further, in the printer 10, the sheet feed roller 12, the platen roller 13, the print head 14, and the cutter 15 are disposed in the housing 11. The printer 10 is provided with a sheet supplying port 16 on one side surface of the housing 11. Further, the printer 10 forms a sheet conveying path such that a leading end of the sheet 19 accommodated in the housing 11 is ejected from the sheet supplying port 16.

The sheet feed roller 12 is disposed most upstream of the sheet conveying path, that is, on a side closest to the paper 19 wound in a roll shape. The sheet feed roller 12 sandwiches the leading end of the sheet 19 fed out from the roll shape between a pair of rollers, and conveys the sheet 19 downstream by a rotational force of the sheet feed roller 12.

The platen roller 13 is disposed downstream of the sheet feed roller 12. The platen roller 13 conveys the sheet 19 fed from the sheet feed roller 12 further downstream by a rotation of the platen roller 13.

The print head 14 is disposed at a position facing the platen roller 13 with the sheet conveying path interposed therebetween. The print head 14 prints an image based on print data on the sheet 19 conveyed on the platen roller 13 in a thermal method.

The cutter 15 is disposed most downstream of the sheet conveying path, that is, in front of the sheet supplying port 16. The cutter 15 includes a fixed blade 151 provided above the sheet conveying path and a movable blade 152 provided below the sheet conveying path with the sheet conveying path interposed between the fixed blade 151 and the movable blade 152. The cutter 15 cuts the sheet 19 ejected from the sheet supplying port 16 in front of the sheet supplying port 16 by pushing the sheet 19 between the movable blade 152 and the fixed blade 151 when the movable blade 152 moves upward. At this time, the partial cut or the full cut is performed in accordance with a movement amount of the movable blade 152. The cutter 15 cuts the sheet 19 based on a cut command from the user terminal 20. “Cutting” includes the partial cutting and the full cutting.

A piece of paper P on a leading end side of the sheet 19 that is fully cut by the cutter 15 drops from the sheet supplying port 16 due to gravity. The printer 10 therefore includes, below the sheet supplying port 16, a box 17 that accommodates the piece of paper P. In the printer 10, the sensor 18 that detects the presence or absence of the sheet 19 ejected from the sheet supplying port 16 is provided in the vicinity of the sheet supplying port 16. The sensor 18 is, for example, an optical sensor, and outputs an ON signal while the sheet 19 is detected, and outputs an OFF signal if the sheet 19 is not detected.

At least one exemplary procedure of processing executed by the processor 101 of the printer 10 will be described.

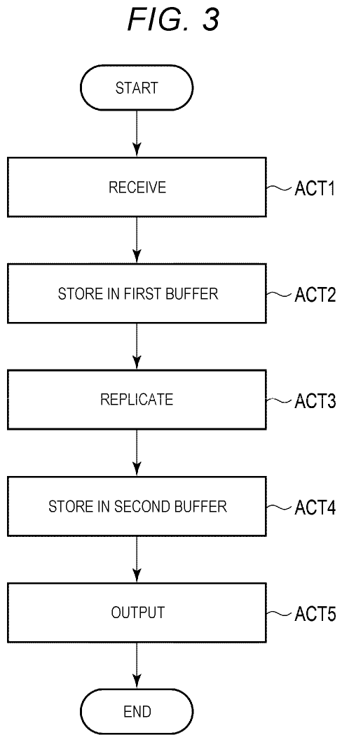

FIG. 3 is a flowchart describing processing of received data executed by the processor 101 of the printer 10 according to at least one exemplary embodiment.

A processing procedure described below is merely an example, and the processing may be changed as much as possible. In the processing procedure described below, the operation may be appropriately omitted, replaced, or added according to the embodiment.

The printer 10 executes the following processing on the received data output from the user terminal 20.

Referring to FIG. 3, the reception unit 121 receives the data from the user terminal 20 via the first communication interface module 104 (ACT 1). In ACT 1, for example, the reception unit 121 receives print data from the user terminal 20 via the first communication interface module 104. The print data is an example of the received data. In another example, the reception unit 121 receives setting information of the printer 10 and the command related to the state of the printer 10 from the user terminal 20 via the first communication interface module 104. The command is an example of the received data.

The storage control unit 122 stores the data received by the reception unit 121 in the first buffer 1041 (ACT 2). The first buffer 1041 stores the received data.

The replication unit 123 generates the second communication data obtained by replicating the received data (ACT 3). In ACT 3, for example, the replication unit 123 replicates the received data stored in the first buffer 1041. In one example, the replication unit 123 replicates the print data stored in the first buffer 1041. The replication unit 123 replicates the print data to generate the second communication data. In another example, the replication unit 123 replicates the command stored in the first buffer 1041. The replication unit 123 replicates the command to generate the second communication data. In this example, the second communication data is data obtained by replicating the received data. The second communication data includes data obtained by replicating the print data or data obtained by replicating the command. After the replication unit 123 replicates the received data, the printer 10 executes processing based on the received data stored in the first buffer 1041. In at least one example, the printer 10 performs printing processing based on the print data. In another example, the printer 10 executes response processing based on the command.

The storage control unit 122 stores the second communication data generated by the replication unit 123 in the second buffer 1051 (ACT 4).

The output unit 124 outputs the second communication data stored in the second buffer 1051 to the analysis terminal 30 via the second communication interface module 105 (ACT 5).

In the exemplary embodiment described above, processing is described in which, after the storage control unit 122 stores the received data in the first buffer 1041, the replication unit 123 generates the second communication data by replicating the received data. However, the disclosure is not limited thereto. Processing may be executed in which, after the replication unit 123 replicates the received data to generate the second communication data, the storage control unit 122 stores the received data in the first buffer 1041.

According to the exemplary embodiment, the storage control unit 122 can store the received data related to the user terminal 20 in the first buffer 1041, and store the second communication data obtained by replicating the received data in the second buffer 1051. Accordingly, the printer 10 can output the print data received from the user terminal 20 or replicated data, such as the command received from the user terminal 20, to the analysis terminal 30 via the second communication interface module 105. Therefore, when analyzing the received data between the printer 10 and the user terminal 20, the printer 10 can provide a replication of the received data to the analysis terminal 30 without using an external analysis device.

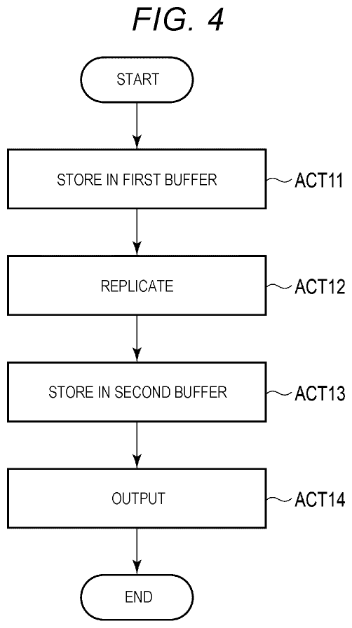

FIG. 4 is a flowchart describing processing of the transmitted data executed by the processor 101 of the printer 10 according to at least one exemplary embodiment.

A processing procedure described below is merely an example, and the processing may be changed as much as possible. In the processing procedure described below, the operation may be appropriately omitted, replaced, or added according to the embodiment.

The printer 10 executes the following processing on the transmitted data output to the user terminal 20.

The processor 101 generates response data based on the command received by the reception unit 121. The response data includes response data for a command related to the setting information of the printer 10 or response data for a command related to the state of the printer 10. The response data is an example of the transmitted data. In the following description, it is assumed that the printer 10 transmits the response data to the user terminal 20.

Referring to FIG. 4, the storage control unit 122 stores the response data output to the user terminal 20 in the first buffer 1041 (ACT 11). The first buffer 1041 stores the response data.

The replication unit 123 generates the second communication data obtained by replicating the response data (ACT 12). In ACT 12, for example, the replication unit 123 replicates the response data stored in the first buffer 1041. The replication unit 123 replicates the response data to generate the second communication data. In at least one example, the second communication data is data obtained by replicating the response data. After the replication unit 123 replicates the response data, the printer 10 executes processing based on the response data. For example, the printer 10 outputs the response data to the user terminal 20.

The storage control unit 122 stores the second communication data generated by the replication unit 123 in the second buffer 1051 (ACT 13).

The output unit 124 outputs the second communication data stored in the second buffer 1051 to the analysis terminal 30 via the second communication interface module 105 (ACT 14).

In the exemplary embodiment described above, processing is described in which, after the storage control unit 122 stores the response data in the first buffer 1041, the replication unit 123 generates the second communication data by replicating the response data. However, the disclosure is not limited thereto. Processing may be executed in which, after the replication unit 123 replicates the response data to generate the second communication data, the storage control unit 122 stores the response data in the first buffer 1041.

According to the exemplary embodiment, the storage control unit 122 can store the transmitted data related to the user terminal 20 in the first buffer 1041, and store the second communication data obtained by replicating the transmitted data in the second buffer 1051. Accordingly, the printer 10 can output the replicated data, such as the response data to be transmitted to the user terminal 20, to the analysis terminal via the second communication interface module 105. Therefore, when analyzing the transmitted data between the printer 10 and the user terminal 20, the printer 10 can provide a replication of the transmitted data to the analysis terminal 30 without using the external analysis device.

As described above, the storage control unit 122 can store the first communication data including the received data or the transmitted data related to the user terminal 20 in the first buffer 1041, and store the second communication data obtained by replicating the first communication data in the second buffer 1051. Accordingly, the printer 10 can output the replicated data of the communication data related to the user terminal 20 to the analysis terminal 30 via the second communication interface module 105. Therefore, when analyzing the communication data between the printer 10 and the user terminal 20, the printer 10 can provide a replication of the communication data to the analysis terminal 30 without using the external analysis device.

In the above-described exemplary embodiment, the printer 10 is described by taking the thermal printer as an example. However, the printer 10 is not limited to the thermal printer. The printer 10 maybe any of various printers such as an inkjet printer.

The first communication interface module 104 is not limited to the USB standard, and may be an integrated circuit that controls communication according to another standard. The first network 40 is not limited to a network implemented by a cable that connects the printer 10 and the user terminal 20 in a wired manner, but may be a network that connects the printer 10 and the user terminal 20 in a wireless manner. The second communication interface module 105 is not limited to a standard such as LAN, Bluetooth (registered trademark), or Wi-Fi (registered trademark), and may be an integrated circuit that controls communication according to another standard.

The program may be transferred in a state of being stored in the electronic device, or may be transferred in a state of not being stored in the electronic device. In the latter case, the program may be transferred via a network, or may be transferred in a state of being recorded in a recording medium. The recording medium is a non-transitory tangible medium. The recording medium is an electronic device readable medium. The recording medium may be a medium such as a CD-ROM or a memory card that can store a program and can be read by an electronic device, and the form of the recording medium is not limited.

In addition, although several exemplary embodiments are described, these embodiments are presented as examples and are not intended to limit scopes of the disclosure. Indeed, the embodiments described herein may be implemented in a variety of other forms, and various omissions, substitutions and changes may be made without departing from the spirit of the disclosure. These embodiments and modifications thereof are included in the scope and spirit of the disclosure and are also included in the disclosure described in the scope of claims and an equivalent scope thereof.

What is claimed is:

1. A printer comprising:
a first communication interface including a first integrated circuit and a first buffer configured to store first communication data, the first communication interface being communicably connected to a user terminal;
a second communication interface including a second integrated circuit and a second buffer configured to store second communication data, the second communication interface being communicably connected to an analysis terminal; and
a processor configured to store the first communication data in the first buffer, and store the second communication data, generated by replicating the first communication data, in the second buffer.

2. The printer according to claim 1, wherein
the first communication interface is a universal serial bus module.

3. The printer according to claim 1, wherein
the first communication data includes at least one of communication data received from the user terminal or communication data output to the user terminal.

4. The printer according to claim 1, wherein
the processor is further configured to output the second communication data stored in the second buffer to the analysis terminal.

5. The printer according to claim 3, wherein
the communication data received from the user terminal includes at least one of print data or a command,
the command includes at least one of a command for causing the printer to output setting information of the printer or a command for causing the printer to output information indicating a state of the printer, and
the state of the printer includes an error occurrence state indicating a jam of the printer.

6. The printer according to claim 1, wherein
the first communication interface is communicably connected to the user terminal via a first network,
the second communication interface is communicably connected to the analysis terminal via a second network, and
the first network and the second network conform to a standard of the first communication interface and the second communication interface, respectively.

7. The printer according to claim 6, wherein the standard of the first communication interface and the second communication interface includes at least one of a wired connection or a wireless connection.

8. An information processing system comprising:
a printer comprising
a first communication interface including a first integrated circuit and a first buffer configured to store first communication data,
a second communication interface including a second integrated circuit and a second buffer configured to store second communication data, and
a processor configured to store the first communication data in the first buffer, and store the second communication data, generated by replicating the first communication data, in the second buffer;
a user terminal communicably connected to the first communication interface and configured to communicate the first communication data with the printer; and
an analysis terminal communicably connected to the second communication interface and configured to communicate the second communication data with the printer.

9. The information processing system according to claim 8, wherein
the first communication interface is a universal serial bus module.

10. The information processing system according to claim 8, wherein
the first communication data includes at least one of communication data received from the user terminal or communication data output to the user terminal.

11. The information processing system according to claim 8, wherein
the processor is further configured to output the second communication data stored in the second buffer to the analysis terminal.

12. The information processing system according to claim 10, wherein
the communication data received from the user terminal includes at least one of print data or a command,
the command includes at least one of a command for causing the printer to output setting information of the printer or a command for causing the printer to output information indicating a state of the printer, and
the state of the printer includes an error occurrence state indicating a jam of the printer.

13. The information processing system according to claim 8, wherein
the first communication interface is communicably connected to the user terminal via a first network,
the second communication interface is communicably connected to the analysis terminal via a second network, and
the first network and the second network conform to a standard of the first communication interface and the second communication interface, respectively.

14. The information processing system according to claim 13, wherein
the standard of the first communication interface and the second communication interface includes at least one of a wired connection or a wireless connection.

15. A method for replicating communication data of an information processing system having a printer including a processor, a first communication interface, and a second communication interface, the method comprising:
receiving, via the first communication interface, first communication data from a user terminal;
storing, by the processor, the first communication data in a first buffer of the first communication interface;
replicating, by the processor, the first communication data to generate second communication data; and
storing, by the processor, the second communication data in a second buffer of the second communication interface.

16. The method according to claim 15, further comprising:
outputting, via the second communication interface, the second communication data stored in the second buffer to an analysis terminal.

17. The method according to claim 15, further comprising:
generating, via the processor, response data in response to a command; and
outputting, via the first communication interface, the response data to the user terminal.
